(19) United States
(12) Patent Application Publication
(10) Pub. No.: US 2021/0387865 A1
(43) Pub. Date: Dec. 16, 2021

(54) WATER DISPENSER WITH MEANS FOR REFRESHING AND IMPROVING WATER QUALITY

(71) Applicant: Yehonatan MORE, Shoham (IL)

(72) Inventor: Yehonatan MORE, Shoham (IL)

(21) Appl. No.: 17/302,652

(22) Filed: May 10, 2021

(30) Foreign Application Priority Data
Jun. 16, 2020 (IL) 275420

(51) Int. Cl. C02F 1/00; C02F 1/48; B01F 13/08

(52) U.S. Cl. CPC C02F 1/005; C02F 1/48; B01F 13/0818; B01F 2215/0052; C02F 2209/06; C02F 2307/10; C02F 2201/48

(57) ABSTRACT

A water dispenser for improving water quality comprising: a transparent water container having an internal and an external side; a container cover; a loudspeaker within the cover playing positive sounds inside the container; a base divided by a partition with an upper and a lower part to hold the water container; a free internal magnet in water located inside the container configured to create a water vortex in the water; an external magnet located in the base upper part connected to an axis configured to mix the water and the free internal magnet; an axis for connecting the external magnet to an external motor in the base lower part; the external motor affixed to the partition and to the axis, configured to rotate the lower external magnet and to rotate the internal magnet to mix the water; and a water tap, through which a user pours water to a receptacle.

### FIELD OF THE INVENTION

The present invention relates to the field of drinking water quality improvement. More particularly, the invention relates to a water dispenser with means for refreshing and improving water quality and taste.

### BACKGROUND OF THE INVENTION

Water is an important human support life resource, which people usually drink from water resources. With the constant growth of people's living standards, much attention is i paid to the temperature, mouth feel, taste clearance, freshness and quality of the water. Such attention becomes increasingly necessary, especially in public places like offices or other workplaces, with personnel.

Conventional prior art methods use pre-packaged drinks, and specifically water, sold by vending machines, equipped with a variety of prepackaged drinks. However, in these kinds of pre-packed drinks (which are manufactured in mass production), the texture and quality of the water/drink cannot effectively meet the demands. For example, when one desires to drink cold water, tea, or hot coffee, this requirement cannot be fulfilled by pre-packaged drinks. For satisfying this requirement, there is a need for a refrigerator for cold water or an electric kettle for hot water.

In order to meet the needs of people drinking hot/cold beverages at home or public places without the need for a refrigerator or electric kettle, offices or other public places are provided with a water bar. However, since a water bar belongs to a relatively harsh field of producing drink water, it is difficult to ensure sanitary conditions, water quality and water taste. Therefore, there is a need to replace expensive parts and components (like filters, UV lamps, etc.) once in a few months, in order to properly maintain the device. This need for replacement of the water bar components increases the operation cost of the water bar. In Addition to the increase in the running cost (which leads to expensive maintenance of the water bar), if the consumer will not replace the necessary parts and components on time, the quality of the water will extremely decrease, and bacteria, fungi, tartar, rust and other contaminants may accumulate inside the water bar and contaminate the drinking water.

Studies showed that when drinking water is mixed, the water molecules, which usually are in a disordered state, become harmoniously arranged. Therefore, if the water will be mixed all the time, their quality and taste will be improved and the water will become fresher.

The study “Effects of Distant Intention on Water Crystal Formation: A Triple-Blind Replication” (Radin et al, Journal of Scientific Exploration, Vol. 22, No. 4, pp. 481-493, 2008) suggested that crystal images in the intentionally treated condition were rated as aesthetically more beautiful than proximal control crystals (p ¼ 0.03, one-tailed). This supports the assumption that intention affects the properties of water. Water exposed to or “treated” by positive intentions results in frozen water crystals that are aesthetically more pleasing than similar crystals formed from “untreated” water.

“Oxidation-Reduction Potential (ORP) for Water Disinfection Monitoring, Control, and Documentation” (Suslow et al., publication 8149, University of California, Davis, 2004, ISBN-13: 978-1-60107-319-8) talks about the fact that ORP sensors allow easy monitoring and tracking of critical disinfectant levels in water systems. Coupled with pH sensors, more-sophisticated systems use ORP sensors to provide automated “demand-based” injection of hypochlorite (or other approved oxidizing disinfectant) and acid, typically food-grade citric acid, muriatic acid, or phosphoric acid.

In addition, other studies showed that music has an influence on water quality, freshness and taste. Sound waves in general, and especially positive words, affect the structure of the water molecule. According to these studies, playing specific sound waves (music), especially with positive words, near the water improves their quality and taste and makes them fresher.

Masaru Emoto suggested that human consciousness has an effect on the molecular structure of water. Emoto's book “The Hidden Messages in Water” published in 2004 disclosed a pseudo-scientific hypothesis that water could react to positive thoughts and words and that polluted water could be cleaned through prayer and positive visualization. Emoto said that water was a “blueprint for our reality” and that emotional “energies” and “vibrations” could change the physical structure of water. Emoto's water crystal experiments consisted of exposing water in glasses to different words, pictures, or music and then freezing and examining the aesthetic properties of the resulting crystals with microscopic photography. He claimed that water exposed to positive speech and thoughts would result in visually “pleasing” crystals being formed when that water was frozen and that negative intention would yield “ugly” frozen crystal formations.

“Water Vortex—Towards Sustainable Technologies” (Jurendić et al., Journal of Basic and Applied Scientific Research, 2013) discusses dynamics of the water molecule(s), and ways to treat water using fractal mathematics and implosion engineering, which exploit water vortex for changing the order of water molecules.

“Alkaline Water and Longevity: A Murine Study” (Margo et al., Evidence-Based Complementary and Alternative Medicine, Volume 2016, Article ID 3084126, 2016) discloses a survival study regarding the biological effect of alkaline water consumption on longevity. The survival study has been conducted on a population of 150 mice and showed that mice watered with alkaline water showed better survival than control mice. Statistical analysis revealed that alkaline water provides higher longevity in terms of “deceleration aging factor” as it increases the survival functions when compared with the control group. Therefore, animals belonging to the population treated with alkaline water resulted in a longer lifespan.

It is therefore an object of the present invention to provide a water bar with means for refreshing and improving water quality, for obtaining high quality, clean (from tartar, rust, minerals, bacteria, etc.), delicious, soft and fresh drinking water.

It is another object of the present invention to provide a water bar with means for obtaining disinfected water with a desired pH and ORP levels, without using electric intervention such as electrolysis.

Other objects and advantages of the invention will become apparent as the description proceeds.

### SUMMARY OF THE INVENTION

A water dispenser with means for refreshing and improving water quality and taste, comprising:
a) a transparent water container (which can be made from glass, plastic, or other transparent materials) for accumulating water;
b) a cover with an opening handle for covering the water container;
c) a loudspeaker with a player, located within the cover, for playing positive sounds (such as music or positive words), nearside the water in the water container;
d) a base (that can be made from iron, wood, etc.) divided by a partition to an upper and lower parts, for holding the water container;
e) a free internal magnet located in the water inside the water container, for mixing the water by rotation, to obtain water vortex;
f) an external magnet located in the base upper part connected to an axis, for mixing the water inside the water container together with the free internal magnet, by rotation;
g) an axis for connecting the external magnet located in the base upper part to an external motor located in the base lower part;
h) an external motor located in the base lower part, affixed to the base partition and connected to the axis, for rotating the lower external magnet which influences and rotates the internal magnet, causing water mixing inside the water container;
i) a water tap, through which a user can pour clean fresh water to a receptacle; and
j) a transformer, connected to an electric cable external, for fitting a suitable voltage level required for the operation of the water dispenser.

The water dispenser may further comprise:
a) a water tube connected to the water container for filling the water container with water;
b) a filter connected to the water tube for filtering the water before entering the water container;
c) a water level detector connected to the water container's cover for checking the water level in the water container at every given moment; and
d) an electric tap for streaming water to the water container according to the water level in the water container, which is detected at every given moment by the water level detector.

The water dispenser may further comprise a mixing speed adjustment element (such as a potentiometer or a transformer), for determining water mixing desired speed by determining external motor rotation speed.

The water dispenser may further comprise LED illumination for illuminating the water dispenser, located in the base upper part.

The water dispenser may further comprise stickers with positive words affixed to the water container on its external side, for creating positive thoughts and a positive experience for a user when drinking water from the water dispenser.

The internal magnet may be wrapped with Teflon (or other isolating material), in order to prevent the internal magnet from touching the drinking water inside the water container.

Water mixing increases the water pH to a level of about 10 and decreases the Oxidation-Reduction Potential (ORP) to a level of about −500.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 shows an illustration of the proposed water bar, according to an embodiment of the present invention; and

FIG. 2 shows an exploded view of the proposed water bar, according to an embodiment of the present invention.

### DETAILED DESCRIPTION OF THE INVENTION

The present invention provides a system for providing disinfected water with the desired pH and ORP levels, which rearranges the water molecules to obtain a desired harmonic order, to thereby remove toxic ingredients and continuously revitalizing the consumed water.

The proposed system may be implemented, for example, as a water bar with means for revitalizing the water by refreshing and improving water quality and taste.

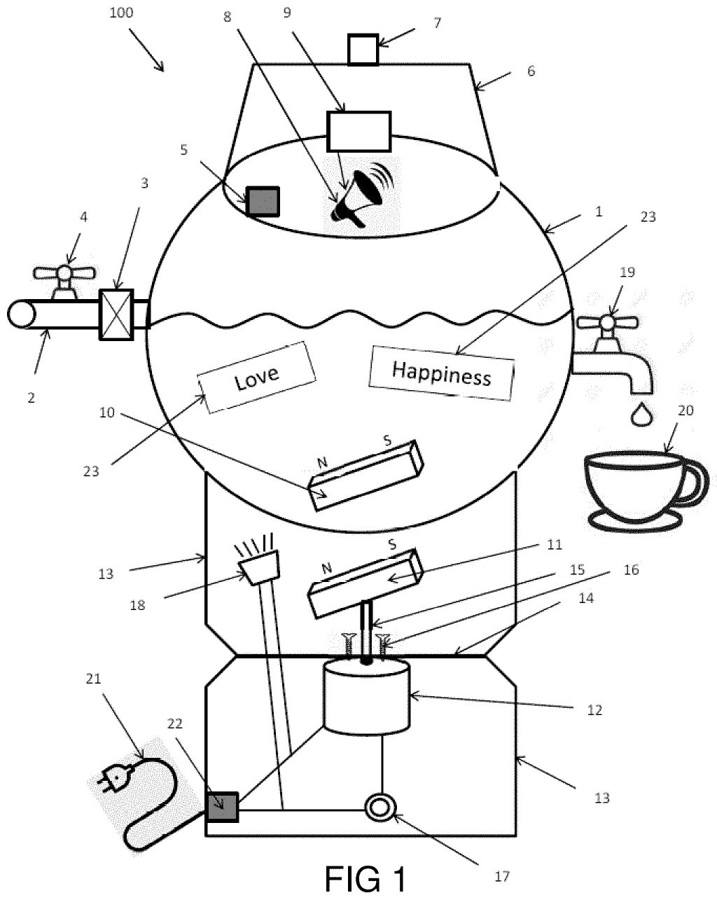

FIG. 1 shows an illustration of the proposed water bar 100, according to an embodiment of the present invention. The drinking water enters a transparent water container (a water tank) 1 (that can be made from glass, plastic, etc.), through water tube 2 with a filter 3 for filtering the water before entering the water container 1, and an electric tap 4. The electric tap 4 streams water to the water container 1 according to the water level in the water container 1, which is detected by a water level detector 5, connected to the water container's cover 6, and checks the water level in the water container at every given moment. The cover 6 of the water container 1 has an opening handle 7 and is connected to a loudspeaker 8 with a player 9, for playing music (mainly music with positive words) nearside the water. Inside the water container 1 there is a free internal (upper) magnet 10 immersed in the water, for mixing the water in the container 1, along with another external (lower) magnet 11, located outside the container 1, in a base 13. The internal magnet 10 is wrapped with Polytetrafluoroethylene (PTFE) (also called “Teflon”), in order to prevent the drinking water inside the water container 1 from touching the internal magnet.

An external motor 12 located inside the base 13 and under the water container 1, rotates the external (lower) magnet 11. Due to the magnetic field interaction between the two magnets, its rotation influences the internal magnet 10 and the internal magnet 10 rotates too. The rotation of the internal magnet 10 and consequently, the external magnet 11, causes a water mixing effect inside the container 1, such that a vortex is generated. The water mixing also increases the water pH to a level of about 10 (for example), and decreases the Oxidation-Reduction Potential (ORP) to a level of about −500 (for example).

The water bar base 13 (can be made from iron, wood, etc.) is divided in the middle into two parts, an upper part and a lower part, by partition 14. In the upper part of the base 13. there is an axis 15 connected to the external (lower) magnet 11 and to the external motor 12 through the partition 14. In the lower part of the base 13 there is the external motor 12, mounted to the base partition 14 with screws 16 (or with other mounting elements). The lower part of the base 13 has a mixing speed adjustment button 17 (connected, for example, to a potentiometer), which enables to choose the water mixing desired speed (by determining the motor 12 rotation speed). In the base 13 upper part, there is also a LED illumination element 18 for illuminating the water bar 100.

The water container 1 is also comprises a water tap 19, through which the user can pour clean fresh water to different receptacles 20 (can be a cup, tank, bottle, bowl, etc.). The external motor 12 and the LED illumination element 18 are connected to the power electricity by an electric cable 21 with a transformer 22 for providing the water bar 100 with the suitable voltage level required for its operation. On the water container 1, there are stickers 23 with positive words (like: “Love”, “Happiness”, etc.) affixed to the container's external side. When the user sees these positive words, he/she may think positive thoughts and have a nice and positive drinking experience. As discussed above, such positive words and thoughts also stimulate positive intentions and result in the improvement of water quality.

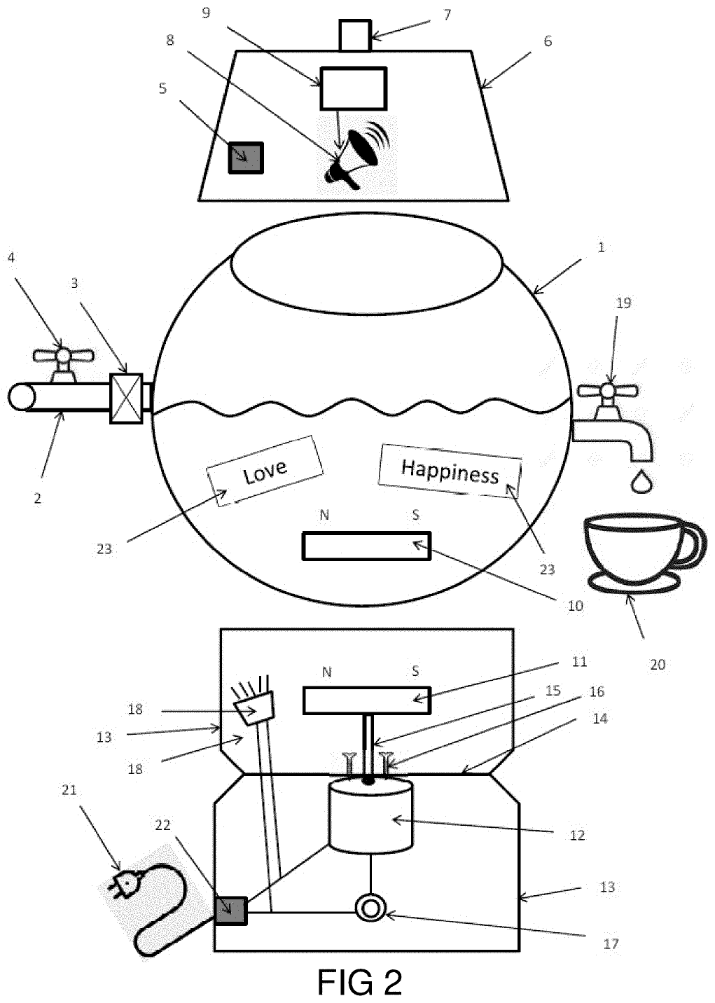

FIG. 2 shows an exploded view of the proposed water bar 100, according to an embodiment of the present invention. At the top of FIG. 2, there is the water container's cover 6 with the opening handle 7. Inside the cover 6 there are the loudspeaker 8, the player 9 and the water level detector 5. At the middle of FIG. 2 there is the water container 1 with the water tube 2, the filter 3 and the electric tap 4 connected to it. Inside the container 1, there is the free upper internal magnet 10 immersed in water inside the water container 1 and the stickers 23 with positive words are affixed to the container 1 on its external (or internal) side.

On the other side of the container 1 there is the water tap 17 and a cup 20 under it for pouring water. The base 13 is shown at the bottom of FIG. 2. In the upper part of the base 13, there are the lower external magnet 11, the axis 15 for connecting the lower magnet 11 to the external motor 12 and the LED illumination element 18. In the lower part of the base 13 there are the external motor 12 connected with the screws 16 to the base partition 14, the mixing speed adjustment button 17 connected to the motor 12 and to the transformer 22, which connected to the external electric cable 21 (for connecting the water bar 100 to the electricity).

According to another embodiment, external filter 3 may be used for purifying the incoming water by using Magnesium minerals, which increase the water pH level and decrease the ORP level. Such purification may be implemented continuously by maintaining a constant circulation of water which is pumped out from the water tank by a water pump, passed through the filter and then returned back into the water tank. This way, the stability of the ORP level is maintained for obtaining the anti-oxidation effect.

As various embodiments have been described and illustrated, it should be understood that variations will be apparent to one skilled in the art without departing from the principles herein. Accordingly, the invention is not to be limited to the specific embodiments described and illustrated in the drawings.

1. A water dispenser with means for refreshing and improving water quality and taste, the water dispenser comprising:
a) a transparent water container for accumulating water, the water container having an internal dispenser comprising:
b) a cover with an opening handle for covering said water container;
c) a loudspeaker with a player, located within said cover, for playing positive sounds, nearside the water in said water container;
d) a base divided by a partition to an upper and a lower parts, for holding said water container;
e) a free internal magnet located in the water inside said water container, configured to mix the water by rotation, to obtain a water vortex;
f) an external magnet located in said base upper part connected to an axis, configured to mix the water inside said water container together with said free internal magnet, by rotation;
g) an axis for connecting said external magnet located in said base upper part to an external motor located in said base lower part;
h) an external motor located in said base lower part, affixed to said base partition and connected to said axis, configured to rotate said lower external magnet and to influence and rotate said internal magnet, to mix water inside said water container;
i) a water tap, through which a user can pour clean fresh water to a receptacle; and
j) a transformer, connected to an electric cable external, for fitting a suitable voltage level required for the operation of said water dispenser.

2. A water dispenser according to claim 1, further comprising a water tube connected to said water container for filling said water container with water;
a) a filter connected to said water tube for filtering the water before entering said water container;
b) a water level detector connected to said water container cover configured to check the water level in said water container at every given moment; and
c) an electric tap configured to stream water to said water container according to the water level in said water container.

3. A water dispenser according to claim 1, further comprising a mixing speed adjustment element, for determining water mixing desired speed by determining external motor rotation speed.

4. A water dispenser according to claim 1, further comprising LED illumination for illuminating said water dispenser, located in said base upper part.

5. A water dispenser according to claim 1, further comprising stickers with positive words affixed to said water container on the external side, for creating positive thoughts and a positive experience for a user when drinking water from said water dispenser.

6. A system according to claim 1, wherein the water container is made from glass, plastic, and other transparent materials.

7. A system according to claim 1, wherein the internal magnet is wrapped with Teflon to prevent the internal magnet from touching the drinking water inside the water container.

8. A water dispenser according to claim 1, wherein the water mixing increases the water pH to a level of about 10 and decreases the Oxidation-Reduction Potential (ORP) to a level of about −500.

9. A water dispenser according to claim 1, wherein the water dispenser base is made from iron and wood.

10. A water dispenser according to claim 1, wherein the positive sounds are selected from the group including: music; and positive words.

11. A water dispenser according to claim 3, wherein the speed adjustment element is a potentiometer and a transformer.
